(19) United States
(12) Patent Application Publication
(10) Pub. No.: US 2010/0306687 A1
(43) Pub. Date: Dec. 2, 2010

(54) SYSTEM AND METHOD FOR AVATAR MANAGEMENT

(75) Inventor: Jie Deng, Shenzhen (CN)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: TENCENT TECHNOLOGY (SHENZHEN) COMPANY LIMITED, Shenzhen (CN)

(21) Appl. No.: 12/856,367

(22) Filed: Aug. 13, 2010

Related U.S. Application Data
(63) Continuation of application No. PCT/CN2009/073060, filed on Aug. 3, 2009.

(30) Foreign Application Priority Data
Sep. 25, 2008 (CN) 200810161380.1

(51) Int. Cl. G06F 15/16; G06F 3/048

(52) U.S. Cl. 715/765; 709/203

(57) ABSTRACT

The present invention provides a system for avatar management, including at least one client and a server, the client is adapted to assemble an avatar according to operation of a user, generate avatar information corresponding to the avatar, transmit the avatar information to the server via a network requesting the server to update the avatar of the user; the server is adapted to parse the avatar information to obtain the corresponding avatar, generate a snapshot based on the avatar, store and manage the avatar information and corresponding snapshot; the server further informs at least one client to update the avatar of the user; and the at least one client updates the avatar of the user according to the snapshot. The present invention also provides a method for avatar management. The present invention can save bandwidth of the server, speed snapshot generation, improve security and accuracy of snapshot generation, and increase system efficiency.

### FIELD OF THE INVENTION

The present invention relates to network application fields, and more particularly, to system and method for avatar management.

### BACKGROUND OF THE INVENTION

In current network systems that provide personal avatar, a user can assemble his/her own avatar. An avatar is defined by avatar information. The avatar information describes each component of the avatar and attributes of the component, including information such as a serial number, a layer identifier, coordinates, size, type and etc. The avatar is used by the user for self-exhibition in various platforms, e.g. WEB application platforms such as a chat window, a forum, a personal space, and so on.

In the prior art, in order to display an avatar at a client, a Flash main engine needs to parse avatar information of the avatar, then the client downloads multiple components from a server via a network, loads and displays the multiple components according to a description in the avatar information. But if a Web application platform displays the avatar in the same manner, there will be excessive network downloading requests which may reduce the processing speed of the Web application platform. For this reason, instead of having to parse the avatar information, the Web application platform may call and display a snapshot of the avatar which is a static image generated based on the avatar. A snapshot of an avatar is often generated by a client which utilizes Flash to snap a screen on which the avatar is displayed. Then the snapshot is transmitted to a server via the network requesting the server to update the avatar. The server stores and manages the snapshot. The snapping of a screen is also called screen capturing which refers to automatically capturing an image of contents in a designated area of a window by a client. The snapshots are generally a large number of bytes, so when the network is busy or the bandwidth is insufficient, a lot of time may be taken in transporting a snapshot through the network. Furthermore, a user may generate a fake or illegal snapshot at the client and submit it to the server, which makes it inconvenient to manage the snapshots and the avatars.

### SUMMARY OF THE INVENTION

Embodiments of the present invention provide a system for avatar management, so as to implement management of avatars.

According to an embodiment of the present invention, a system for avatar management is provided. The system may include: at least one client and a server, the at least one client is adapted to assemble an avatar according to operation of a user, generate avatar information corresponding to the avatar, and transmit the avatar information to the server via a network requesting the server to update the avatar; the server is adapted to parse the avatar information to obtain the avatar, generate a snapshot based on the avatar, store and manage the avatar information and the snapshot corresponding to the avatar information, instruct at least one client to update the avatar of the user; the at least one client is adapted to update the avatar of the user according to the snapshot.

According to another embodiment of the present invention, a method for avatar managing is provided. The method implements management of avatars based on an avatar management system which includes at least a client and a server. The method may include: assembling, by the at least one client, an avatar according to operation of a user, generate avatar information corresponding to the avatar, transmitting the avatar information to the server requesting the server to update the avatar of the user; parsing, by the server, the avatar information to obtain the avatar, generating a snapshot based on the avatar, storing and managing the avatar information and the snapshot corresponding to the avatar information; instructing, by the server, at least one client to update the avatar of the user; updating, by the at least one client, the avatar of the user according to the snapshot.

The system and method for avatar management provided by the present invention can save bandwidth of the server, increase the speed of snapshot generation, improve security and accuracy of snapshot generation, and increase the efficiency of the system for avatar management.

### BRIEF DESCRIPTION OF THE DRAWINGS

FIG. 1 is a schematic illustrating a structure of a system for avatar management in accordance with embodiment one of the present invention.

FIG. 2 is a schematic illustrating a detailed structure of a system for avatar management in accordance with embodiment two of the present invention.

FIG. 3 is a schematic illustrating a working procedure of server 2 in accordance with embodiments two and five of the present invention.

FIG. 4 is a schematic illustrating a structure of avatar managing module 22 in accordance with embodiment three of the present invention.

FIG. 5 is a schematic illustrating a process for removing a request in accordance with embodiments three and six of the present invention.

FIG. 6 is a flowchart illustrating a method for avatar management in accordance with embodiment four of the present invention.

The objective, functions and merits of the present invention will be described in detail hereinafter with reference to the accompanying drawings and embodiments.

### DETAILED DESCRIPTION OF THE INVENTION

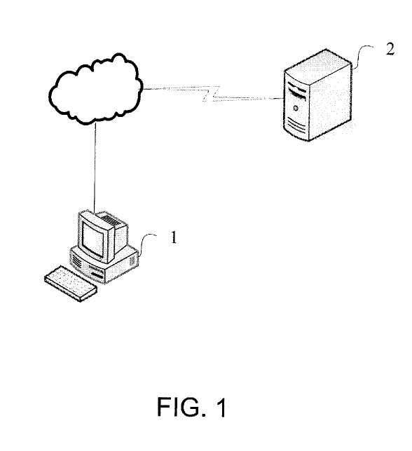

The system for avatar management provided by embodiment one of the present invention is shown as FIG. 1. The system may include at least one client 1 and server 2. The at least one client 1 respectively assembles an avatar according to operation of a user and generates avatar information corresponding to the avatar, transmits the avatar information to server 2 via a network requesting server 2 to update the avatar of the user. Server 2 parses the avatar information and obtains the avatar, generates a snapshot based on the avatar, stores and manages the avatar information and the snapshot corresponding to the avatar information. The server instructs at least one client to update the avatar of the user. The at least one client updates the avatar of the user according to the snapshot. The above avatar is prepared at the client by the user. The avatar information refers to information describing the avatar.

In this embodiment, parsing of the avatar information and generating of the snapshot are performed by server 2, which reduces processing workload of the client and reduces the amount of data transmitted over the network, thus enhances management efficiency and security.

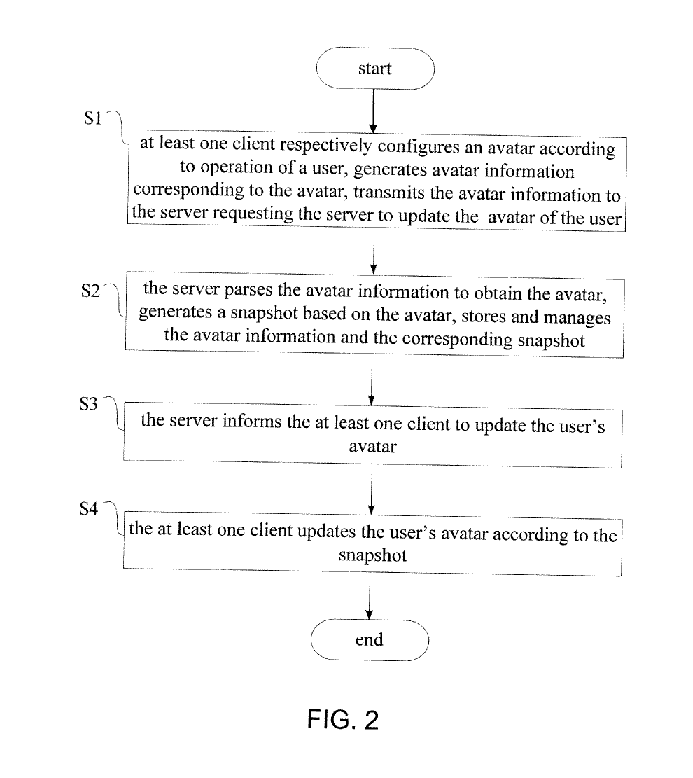

Based on the above embodiment, embodiment two is provided as shown in FIG. 2. Referring to FIG. 2, client 1 includes avatar assembling module 11, adapted to provide a user with components, generate an avatar according to operation of the user, and generate avatar information corresponding to the avatar. Server 2 includes avatar transmitting module 21, avatar managing module 22 and service recording module 23. Avatar transmitting module 21 receives the avatar information transmitted by client 1 via a network. Avatar managing module 22 is adapted to parse the avatar information to obtain the avatar and generate a snapshot based on the avatar. Service recording module 23 is adapted to record and manage a snapshot generation result. The snapshot generation result refers to a result of a series of processing including server 2 parsing the avatar information to obtain the avatar and generating the snapshot based on the avatar. There are two possible snapshot generation results, i.e., snapshot generation succeeded and snapshot generation failed.

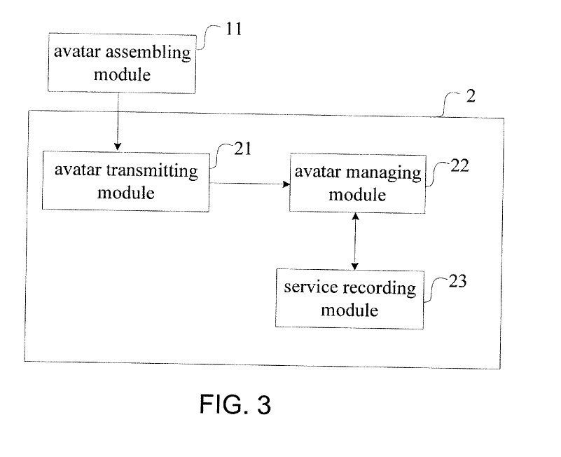

Referring to FIG. 3, a working procedure of server 2 in this embodiment may include the steps as follows.

In step S21, avatar transmitting module 21 receives avatar information transmitted by client 1.

In step S22, avatar transmitting module 21 sends the avatar information to avatar managing module 22.

In step S23, avatar managing module 22 parses the avatar information and obtains an avatar corresponding to the avatar information.

In step S24, avatar managing module 22 generates a snapshot based on the avatar, stores and manages the avatar information and corresponding snapshot.

If the snapshot generation result in this step is snapshot generation succeeded, avatar managing module 22 updates a snapshot originally stored with the snapshot generated in this step.

In step S25, avatar managing module 22 transmits the avatar information and the snapshot generation result to service recording module 23.

In step S26, service recording module 23 records and manages the avatar information and the snapshot generation result.

Step S27, server 2 instructs at least one client 1 to update the avatar of the user and transmits the updated snapshot.

Since there is one-to-one correspondence between the user and the avatar, for facilitating management, the avatar information in this embodiment is further associated with user information to form a relation between the avatar information and the user information. The user information may be an account or an ID of the user in the avatar management system.

In this embodiment, avatar assembling module 11 of client 1 obtains the components from server 2 and provides the components for the user to select from, then assembles an avatar according to the user's operation and generates avatar information corresponding to the avatar. In one embodiment, the components may include serial numbers or identifiers of components for five sense organs, hats, clothes, trinkets, pets and/or scenes. Each component has attributes including position, size, direction, layer identifier, coordinates, type and/or total number of the component, etc. The components and corresponding attributes collaboratively form an avatar. Generating avatar information refers to arranging each component of the avatar and corresponding attributes in a certain order according to a pre-determined format. The avatar information may be arranged into a character string in a pre-defined format or into a file of a format such as XML (eXtensible Markup Language), and so on. The format of the character string is generally arranged in the following manner: components and corresponding attributes arranged in sequence with a separator, such as a comma, between each component and corresponding attributes. Since a character string is hard to read and understand, for facilitating management and query, if the avatar information generated and transmitted by avatar assembling module 11 is a character string in the pre-defined format, avatar transmitting module 21 may convert the character string in the pre-defined format into a file in a format such as XML.

Specifically, the step 22 of avatar transmitting module 21 transmitting the avatar information to avatar managing module 22 may include steps as follows.

In step S221, avatar transmitting module 21 converts the avatar information into a file of a format.

In step S222, avatar transmitting module 21 associates the avatar information with the user information.

In step S223, avatar transmitting module 21 transmits the avatar information and corresponding user information to avatar managing module 22.

In this embodiment, avatar managing module 22 may be implemented by a window application based on WINDOWS so as to not only implement avatar analysis but also implement snapshot generation by directly utilizing a WINDOWS snap-screen component, and may further implement avatar information storing and management.

In step S23, avatar managing module 22 parses the avatar information to obtain the avatar corresponding to the avatar information. Specifically, avatar managing module 22 reads out the avatar information, obtains all components composing the avatar and attributes of the components, loads all the components according to description in the avatar information, and obtains an avatar which is the same with the avatar assembled by the user at client 1.

In step S24, avatar managing module 22 generates a snapshot based on the avatar, stores and manages the avatar information and the snapshot corresponding to the avatar information. Specifically, avatar managing module 22 calls a WINDOWS snap-screen component to automatically take a picture of the avatar, takes a static image obtained as the snapshot of the avatar, stores and manages the avatar information and corresponding snapshot.

Taking generation of a snapshot in GIF format as an example, avatar managing module 22 stores the snapshot as an image file in GIF format, and names the image file after user information to generate an image file named “user information.gif”, so as to associate the snapshot with the user information. When client 1 needs to obtain the snapshot, avatar managing module 22 searches for the image file corresponding to the user based on the user information transmitted by client 1 and transmits the image file to client 1.

In step S25, avatar managing module 22 transmits the avatar information and a snapshot generation result to service recording module 23. Specifically, avatar managing module 22 obtains the snapshot generation result according to whether steps S21 to S24 are executed successfully or failed, transmits the avatar information together with the user account or ID, time of user's request and the snapshot generation result to service recording module 23.

In step S26, service recording module 23 records and manages the avatar information and the snapshot generation result. Specifically, service recording module 23 receives the avatar information, the user account or ID, the time of user's request and the snapshot generation result transmitted by avatar managing module 22, and manages and stores the above information into a log file for maintenance and query.

In step S27, server 2 informs at least one client 1 to update the user's avatar. Specifically, server 2 searches for at least one client 1 which is using the avatar, and transmits an update notification to the at least one client 1 found. The update notification includes the user account or ID and an updated snapshot.

After receiving the update notification, the at least one client 1 displays the updated snapshot in an avatar displaying window corresponding to the user according to the user account or ID and the updated snapshot received.

Suppose user A is chatting with user B and user C respectively, and user D is viewing a profile of user A. A chat interface and a profile displaying interface both include an avatar displaying window corresponding to user A for displaying the avatar of user A. After the avatar of user A is updated, server 2 transmits an update notification to clients of user A, user B, user C and user D respectively. The clients respectively display the updated snapshot received in the avatar displaying window corresponding to user A. Thus, the update of the avatar of user A is implemented.

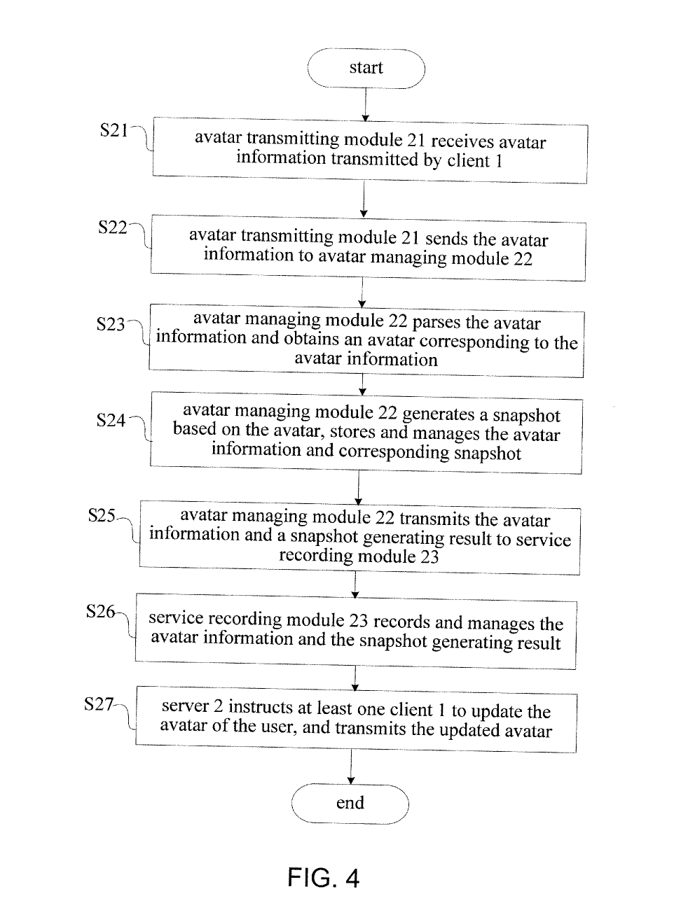

Based on the above embodiment, embodiment three is provided. As shown in FIG. 4, avatar managing module 22 includes avatar parsing unit 221 and avatar storage unit 222. Avatar parsing module 221 parses avatar information to obtain an avatar corresponding to the avatar information and generates a snapshot based on the avatar. Avatar storing module 222 stores and manages the avatar information and the snapshot corresponding to the avatar information. Avatar parsing module 221 of this embodiment may be implemented by a plug-in installed in a browser. For example, a process with a plug-in can be installed in a Firefox browser which calls a built-in FLASH plug-in to parse the avatar using AS3 language (ActionScript 3.0, a Flash programming language) and perform graphic coding to obtain the avatar. Avatar parsing module 221 generates the snapshot of the avatar utilizing the built-in plug-in, and transmits the avatar information and corresponding snapshot to the avatar storing module 222 for storage and management.

Avatar parsing module 221 in this embodiment may also not be based on the browser, but be implemented by other FLASH players.

A Flash player process generates a lossless Portable Network Graphic (PNG) format snapshot by default. The snapshot generated may have a large number of bytes and occupies large space. When the snapshot is to be transmitted to multiple clients through the network, the transmission may be time-consuming, which is very inconvenient for users. In order to improve the efficiency, this embodiment of the present invention provides a method of compressing the snapshot into an image in a format such as GIF, JPG which have less bytes. Thus, server 2 in this embodiment of the present invention may further include graphics processing base 24, adapted to receive the snapshot generated by avatar parsing module 221, compress and convert the snapshot into a snapshot having less bytes, and replace the snapshot having a large number of bytes with the converted snapshot having less bytes.

When multiple clients connected with server 2 transmit avatar update requests or avatar obtaining requests to the server at the same time, there may be multiple requests waiting to be processed by server 2. Thus, this embodiment proposes a request queue to manage the multiple requests. The queue adopts first-in-first-out principle, i.e., multiple requests from the at least one client are inputted into the queue in the order the requests are received by server 2 and the request first inputted into the queue is processed first. After receiving a request, avatar transmitting module 21 puts the request at the tail of the queue. Avatar managing module 22 reads out a request from the head of the queue to process the request.

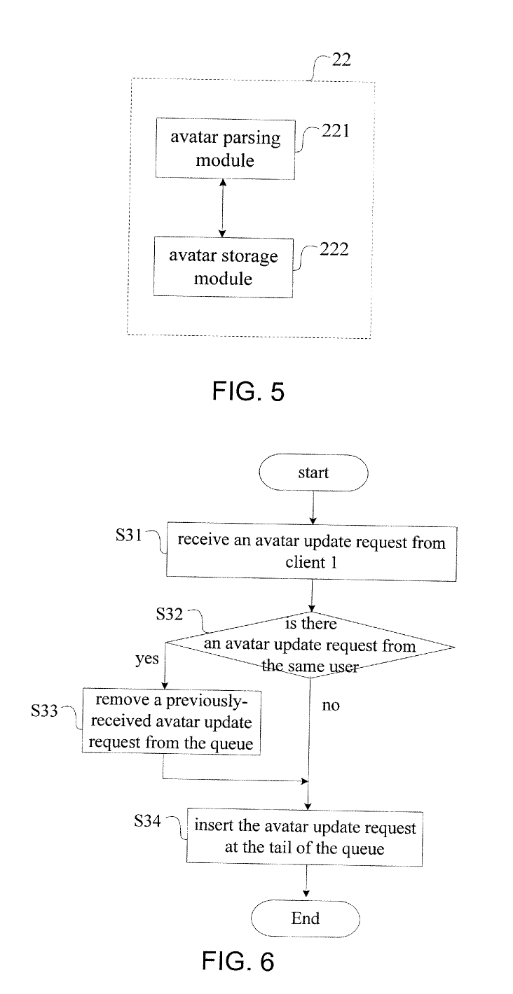

In practice, a user may frequently perform the avatar-assembling operation and transmit multiple avatar update requests in a short time. For example, a user may frequently use hairstyle 1, hairstyle 2 and hairstyle 3 in turn for the avatar with an avatar update request transmitted each time the hairstyle of the avatar is changed. In this situation, server 2 may receive an avatar update request before a previous avatar update request from the same user is processed. In order to reduce the workload of server 2, this embodiment enables removal of at least one request transmitted by the same user from the queue and only processing the latest request of the user. Specifically, referring to FIG. 5, the process of removing a request may include steps as follows.

In step S31, an avatar update request is received from client 1.

In step S32, the queue is searched to determine whether there is an avatar update request from the same user in the queue; if there is, step S33 will be performed; otherwise, step S34 will be performed.

In step S33, a previously-received avatar update request is removed from the queue.

In step S34, the avatar update request is inserted at the tail of the queue.

Furthermore, when there are too many clients, to ensure that all the clients can visit server 2 successfully and efficiently, server 2 may be a server cluster including a plurality of distributed servers. Avatar managing module 22 respectively generates at least one copy of the snapshot of at least one client, distributes the at least one copy to the plurality of distributed servers and informs service recording module 23 of the distribution process according to which service recording module 23 generates a snapshot distribution log. The distributed servers respectively receive and manage snapshots. When receiving an avatar obtaining request from a client, a distributed server searches snapshots stored, finds a snapshot corresponding to user information in the request and returns the snapshot to the client.

Based on the above embodiments, the present invention proposes that, when an avatar of a user is failed to be parsed to generate a snapshot, a second try may be carried out to parse the avatar and generate a snapshot. Specifically, service recording module 23 may provide the recorded avatar information, user account or ID, time of user's request and snapshot generation result for server 2 to query. At a pre-defined time point, a checking procedure may be initiated by service recording module 23 or a less-loaded avatar storing module 222 to inspect the log file for a snapshot generation result recorded as failed. Then avatar information corresponding to the snapshot generation result found is obtained, and another attempt is carried out for parsing the avatar information and generating a snapshot until the avatar information is successfully parsed and a snapshot is generated.

As shown in FIG. 6, the present invention also provides a method for avatar management which implements avatar management based on the avatar management system including at least one client 1 and server 2. The method for avatar management may include steps as follows.

In step S1, at least one client 1 each assembles an avatar according to operation of a user and generates avatar information corresponding to the avatar, transmits the avatar information to the server requesting the server to update the user's avatar.

In step S2, the server parses the avatar information to obtain the avatar, generates a snapshot based on the avatar, stores and manages the avatar information and the snapshot corresponding to the avatar information.

In step S3, the server informs at least one client to update the user's avatar.

In step S4, the at least one client updates the user's avatar according to the snapshot.

The parsing avatar information to obtain the avatar by server 2 in the above step S3 may include: reading out the avatar information, obtaining components forming the avatar and attributes of the components, loading all the components forming the avatar according to a description in the avatar information to obtain the same avatar as that assembled by the user at the client.

The generating snapshot based on the avatar by the server in the above step S3 may include: taking a picture of the screen on which the avatar is displayed and taking a static image obtained as the snapshot.

The avatar is assembled by the user at the client. Information describing the avatar is referred to as the avatar information.

Based on the above embodiment, the present invention provides embodiment five. In this embodiment, client 1 includes avatar assembling module 11, adapted to provide components for a user, generate an avatar based on the components according to operation of a user, and generate avatar information corresponding to the avatar. Server 2 includes avatar transmitting module 21, avatar managing module 22 and service recording module 23.

As shown in FIG. 3, a working procedure of server 2 in this embodiment may include the steps as follows.

In step S21, avatar transmitting module 21 receives avatar information transmitted by client 1.

In step S22, avatar transmitting module 21 transmits the avatar information to avatar managing module 22.

In step S23, avatar managing module 22 parses the avatar information to obtain the avatar corresponding to the avatar information.

In step S24, avatar managing module 22 generates the snapshot based on the avatar, stores and manages the avatar information and the snapshot corresponding to the avatar information.

In step S25, avatar managing module 22 transmits the avatar information and a snapshot generation result to service recording module 23.

In step S26, service recording module 23 records and manages the avatar information and the snapshot generation result.

In step S27, server 2 informs at least one client 1 to update the user's avatar and transmits an updated snapshot.

The snapshot generation result refers to the result of a series of processing including server 2 parsing the avatar information to obtain the avatar and generating the snapshot based on the avatar, and so on. The value of the snapshot generation result may be snapshot generation succeeded or snapshot generation failed.

Since there is a one-to-one correspondence between the user and the avatar, for facilitating management, the avatar information in this embodiment is further associated with user information to form a relation between the avatar information and the user information. The user information may be an account or an ID of the user in the avatar management system.

In this embodiment, if the avatar information generated by avatar assembling module 11 is a character string in a pre-defined format, avatar transmitting module 21 may further convert the character string in the pre-defined format into a file in a format such as XML.

Specifically, in step S22, avatar transmitting module 21 transmitting the avatar information to avatar managing module 22 may include steps as follows.

In step S221, avatar transmitting module 21 converts the avatar information into a file in a format.

In step S222, avatar transmitting module 21 associates the avatar information with the user information.

In step S223, avatar transmitting module 21 transmits the avatar information and corresponding user information to avatar managing module 22.

In above step S23, avatar managing module 22 parsing the avatar information to obtain the avatar corresponding to the avatar information specifically includes: reading out the avatar information, obtaining all components forming the avatar and attributes of the components, loading all the components forming the avatar according to description in the avatar information, and obtaining an avatar which is the same as the avatar assembled by the user at client 1.

In step S24, avatar managing module 22 generates a snapshot based on the avatar, stores and manages the avatar information and the snapshot corresponding to the avatar information. Specifically, avatar managing module 22 automatically takes a picture of the screen on which the avatar is displayed, takes a static image obtained as the snapshot, stores and manages the avatar information and the snapshot corresponding to the avatar information.

In step S25, avatar managing module 22 transmits the avatar information and a snapshot generation result to service recording module 23. Specifically, avatar managing module 22 obtains the snapshot generation result according to whether the steps S21 to S24 are successfully executed or failed, transmits the avatar information, the user account or ID, time of user's request and the snapshot generation result to service recording module 23.

In step S26, service recording module 23 records and manages the avatar information and the snapshot generation result. Specifically, service recording module 23 receives the avatar information, the user account or ID, the time of user's request and the snapshot generation result transmitted by avatar managing module 22, manages and stores the above information received as a log file for maintenance and query.

In step S27, server 2 informs at least one client 1 to update the user's avatar. Specifically, server 2 searches for at least one client 1 which is using the avatar, transmits an update notification to the at least one client 1 respectively. The update notification includes the user account or ID and the updated snapshot.

When receiving the update notification, the at least one client 1 displays the updated avatar in an avatar displaying window of the user corresponding to the updated avatar according to the user account or ID and the updated snapshot received.

According to this embodiment, besides generating the snapshot and storing and managing the avatar information and the corresponding snapshot in step S24, avatar managing module 22 may further compress and convert the snapshot to generate a snapshot having less bytes to replace the snapshot having a larger number of bytes.

Also in this embodiment, if the process of parsing of the avatar information and generating of the snapshot of the avatar of a particular user is failed, another attempt may be carried out for parsing the avatar information and generating the snapshot. Specifically, service recording module 23 may provide the recorded avatar information, user account or ID, user requesting time and snapshot generation result for server 2 to query. At a pre-defined time point, service recording module 23 or a less-loaded avatar storing module 222 may initiate a checking procedure to inspect the log file for snapshot generation results recorded as failed, then obtains the avatar information corresponding to the snapshot generation result found, and attempts to parse the avatar information and generate a snapshot until the avatar information is successfully parsed and the snapshot is generated.

Based on the above embodiment, embodiment six of the present invention is provided. In this embodiment, a request queue is set for managing multiple requests. The queue adopts a first-in-first-out principle, i.e., multiple requests from at least one client are inputted into the queue in the order the requests are received by server 2 and the request first inputted into the queue is processed first. After receiving a request, avatar transmitting module 21 put the request at the tail of the queue. Avatar managing module 22 reads out a request from the head of the queue to process the request.

This embodiment may remove at least one request transmitted by the same user from the queue and only process the latest request. Specifically, referring to FIG. 5, the removal of a request may include the steps as follows.

In step S31, an avatar update request is received from client 1.

In step S32, the queue is searched to determine whether there is an avatar update request from the same user in the queue; if there is, step S33 will be performed; otherwise, step S34 will be performed.

In step S33, a previously-received avatar update request is removed from the queue.

In step S34, the avatar update request is put at the tail of the queue.

This embodiment also provides a method for avatar management. Server 2 may be a server cluster including a plurality of distributed servers. The method for avatar management may include: generating at least one copy of a snapshot of at least one client, distributing the at least one copy to the plurality of distributed servers and informing service recording module 23 of the distribution process according to which service recording module 23 generates a snapshot distribution log. The distributed servers receive and manage the snapshot respectively. When receiving an avatar obtaining request from a client, a distributed server searches snapshots stored for a snapshot corresponding to the user information in the request and returns the snapshot to the client.

The foregoing descriptions are only preferred embodiments of this invention and are not for use in limiting the protection scope thereof. Any changes and modifications can be made by those skilled in the art without departing from the spirit of this invention and therefore should be covered within the protection scope as set by the appended claims.

1. A system for avatar management, comprising a client and a server, wherein
the client is adapted to assemble an avatar according to operation of a first user, generate avatar information corresponding to the avatar, transmit the avatar information to the server via a network requesting the server to update the avatar of the first user, updating an avatar of a second user according to a snapshot when the client is instructed by the server to update the avatar of the second user;
the server is adapted to parse the avatar information to obtain the avatar corresponding to the avatar information, generate a snapshot based on the avatar, store and manage the avatar information and the snapshot corresponding to the avatar information, instruct the client to update the avatar of the second user.

2. The system of claim 1, wherein the server is further adapted to: transmit an updated snapshot of the second user to the client;
the client is adapted to update the avatar of the second user according to the updated snapshot of the second user transmitted by the server.

3. The system of claim 1, wherein
the client comprises an avatar assembling module, adapted to provide components for the user, generate the avatar according to operation of the user, and generate the avatar information corresponding to the avatar.

4. The system of claim 1, wherein
the server comprises an avatar transmitting module, an avatar managing module and a service recording module;
the avatar transmitting module is adapted to receive the avatar information transmitted by the client via the network;
the avatar managing module is adapted to parse the avatar information to obtain the avatar corresponding to the avatar information, and generate the snapshot based on the avatar; and
the service recording module is adapted to record and manage a snapshot generation result.

5. The system of claim 4, wherein
the avatar managing module comprises an avatar parsing module and an avatar storing module;
the avatar parsing module is adapted to parse the avatar information to obtain the avatar corresponding to the avatar information, and generate the snapshot based on the avatar; and
the avatar storing module is adapted to store and manage the avatar information and the snapshot corresponding to the avatar information.

6. The system of claim 4, wherein
the avatar transmitting module is further adapted to receive the avatar information from the client, convert the avatar information into a file in a format, and transmit the avatar information and user information corresponding to the avatar information to the avatar managing module.

7. The system of claim 8, wherein
the server is a server cluster comprising a plurality of distributed servers;
the avatar managing module is adapted to generate at least one copy of the snapshot of the client, distribute the at least one copy to the plurality of distributed servers, inform the service recording module of the distribution process;
the service recording module is adapted to generate a snapshot distribution log based on the distribution process; and
each of the distributed servers is adapted to receive and manage the copy of the snapshot, search, according to an avatar obtaining request received from the client, stored snapshots for a snapshot corresponding to user information in the avatar obtaining request, and return the snapshot to the client.

8. A method for avatar management based on an avatar management system comprising a client and a server, comprising:
assembling, by the client, an avatar according to operation of a first user, generating avatar information corresponding to the avatar, transmitting the avatar information to the server requesting the server to update the avatar of the first user;
parsing, by the server, the avatar information to obtain the avatar, generating a snapshot based on the avatar, storing and managing the avatar information and the snapshot corresponding to the avatar information;
informing, by the server, the client to update an avatar of a second user; and
updating, by the client, the avatar of the second user according to the snapshot.

9. The method for avatar management of claim 8, wherein informing by the server the client to update the avatar of a second user comprises:
transmitting, by the server, an updated snapshot of the second user to the client.

10. The method of claim 8, wherein parsing by the server the avatar information to obtain the avatar corresponding to the avatar information comprises:
reading out the avatar information, obtaining components forming the avatar and attributes of the components, loading all the components forming the avatar according to a description in the avatar information, and obtaining an avatar the same as the avatar assembled by the first user at the client.

11. The method of claim 8, wherein generating by the server the snapshot based on the avatar comprises:
taking a picture of a screen on which the avatar is displayed, taking a static image obtained as the snapshot.

12. The method of claim 8, further comprising:
recording the avatar information and a snapshot generation result;
inspecting records for a snapshot generation result recorded as snapshot generation failed, obtaining avatar information corresponding to the snapshot generation result found, taking another attempt for parsing the avatar information and generating a snapshot.
